(19) United States
(12) Patent Application Publication
(10) Pub. No.: US 2016/0364682 A1
(43) Pub. Date: Dec. 15, 2016

(54) WIRED HIERARCHICAL INVENTORY SYSTEM

(71) Applicant: International Business Machines Corporation, Armonk, CA (US)

(72) Inventors: Gregory S. Jones, Lewisville, TX (US); Olivia G. Loza, Denton, TX (US); Matthew M. Nemati, Carrollton, TX (US); John S. Pannell, Keller, TX (US)

(21) Appl. No.: 14/737,696

(22) Filed: Jun. 12, 2015

(51) Int. Cl. G06Q 10/08; G06K 7/10

(52) U.S. Cl. CPC G06Q 10/087; G06K 7/10366

(57) ABSTRACT

The system for inventory management includes a plurality of tags, a root tag connected via a wire to at least one tag of the plurality of tags, and a reading device. Each tag of the plurality of tags corresponds to an item and each tag of the plurality of tags is connected via a wire to at least one other tag of the plurality of tags. The reading device is connected to the root tag to receive data found on the plurality and the data is transferred to the reading device through one or more wires connected to the root tag.

### BACKGROUND OF THE INVENTION

The present invention relates generally to the field of inventory systems, and more particularly to wired inventory systems.

An inventory system is a process for managing and locating objects, materials, or items. Modern inventory systems often rely upon barcodes and/or RFID (radio-frequency identification) tags to provide automatic identification of things being inventoried. Objects, materials, or items being inventoried may include any kind of physical asset, for example, merchandise, consumables, fixed assets, circulating tools, library books, or capital equipment, to name a few. To record transactions of things being inventoried, inventory systems may use a barcode scanner or RFID reader to automatically identify the inventory object, material, or item, and then collect additional about the object, material, or item via a device.

### SUMMARY

Embodiments of the present invention include a system for inventory management. In one embodiment, the system includes a plurality of tags, a root tag connected via a wire to at least one tag of the plurality of tags, and a reading device. Each tag of the plurality of tags corresponds to an item and each tag of the plurality of tags is connected via a wire to at least one other tag of the plurality of tags. The reading device is connected to the root tag to receive data found on the plurality and the data is transferred to the reading device through one or more wires connected to the root tag.

Embodiments of the present invention include a method for inventory management. In one embodiment, data is received through a root tag that is connected via a wire to at least one tag of a plurality of tags. The data is received by a reading device connected to the root tag. Each tag of the plurality of tags corresponds to an item. Each tag of the plurality of tags is connected via a wire to at least one other tag of the plurality of tags.

Embodiments of the present invention include a computer program product for inventory management. In one embodiment, the computer program product includes one or more computer readable storage media and program instructions stored on the one or more computer readable storage media. The program instructions receive data through a root tag that is connected via a wire to at least one tag of a plurality of tags. The data is received by a reading device connected to the root tag. Each tag of the plurality of tags corresponds to an item. Each tag of the plurality of tags is connected via a wire to at least one other tag of the plurality of tags.

### BRIEF DESCRIPTION OF THE DRAWINGS

FIG. 1 is a functional block diagram of a data processing environment, in accordance with an embodiment of the present invention;

FIG. 2 is a functional block diagram of a tag, in accordance with an embodiment of the present invention;

FIG. 3 is a flowchart depicting operational steps for data processing in a wired environment, in accordance with an embodiment of the present invention;

FIG. 4 depicts a block diagram of components of the reading device of FIG. 1, in accordance with an embodiment of the present invention.

### DETAILED DESCRIPTION

Embodiments of the present invention provide for data processing in a wired environment. Embodiments of the present invention provide for receiving data in a hierarchical structure related to tags in a wired environment. Embodiments of the present invention provide for receiving data about sensors attached to tags in a wired environment. Embodiments of the present invention provide for receiving, analysis, and displaying of data in a wired environment. Embodiments, of the invention provide a system and method for providing real-time automatic identification, location, and inventory of items.

Embodiments of the present invention recognize that there are instances where current inventory systems, for example Radio-frequency identification (RFID), barcode, and other common technologies, are either impossible or impractical. Often, equipment will be stored in devices that are metal in nature (i.e. metal storage boxes) preventing the use of RFID and making the use of barcode or other visual scanning technologies overly labor intensive. Another example includes items which are only used in case of emergencies and are stored in locations that are not in full view but these items must be inventoried or inspected on a regular basis for safety and/or regulatory purposes.

Embodiments of the present invention allow for the tracking of items by placing an identifying tag on each item to be tracked. The tags allow for any level of item identification needed, from simply identifying the type of item to which the tag is attached (similar to a UPC (Universal Product Code)), or providing a unique identifier to enable the identification of the special serialized individual item to which the tag is attached (similar to an RFID (Radio-Frequency Identification) tag). Embodiments of the present invention allow for tracking of items where the data that is sent includes information that allows for the creation of the hierarchical network that allows for the tracking of relationships between items that the tags are attached to. Embodiments of the present invention allow for a device to be connected to one of the tags and for the device to receive information or data about the tag the device is connected to and for the device to receive information or data about any tag connected to the tag the device is connected to.

Embodiments of the present invention recognize that wired tags are usable within containers, for example metal containers, that block wireless signals and that would require the opening of the container or mounting an expensive RFID reading inside the container for inventorying. Embodiments of the present invention recognize that wired tags may be more reliable than wireless tags because the proximity of items, for example metal objects of containers of liquids, to the tags can block and reflect signals from tags and prevent tags from being read. Embodiments of the present invention recognize that wired tags provide a level of security due to the lack of wireless transmission of data. Embodiments of the present invention recognize there is a business value in knowing the hierarchical or parent-child relationships between tags and that there is a labor savings and error reductions that comes from not having to manually record the new locations of tagged items when they are placed in tagged storage locations or tagged containers. Embodiments of the present invention recognize that when items are moved to new inventory locations, one tag can be inventoried to inventory an entire inventory system and each individual item or tag does not have to be inventoried, reducing the risk of exposure of sensitive inventory data for the inventory system.

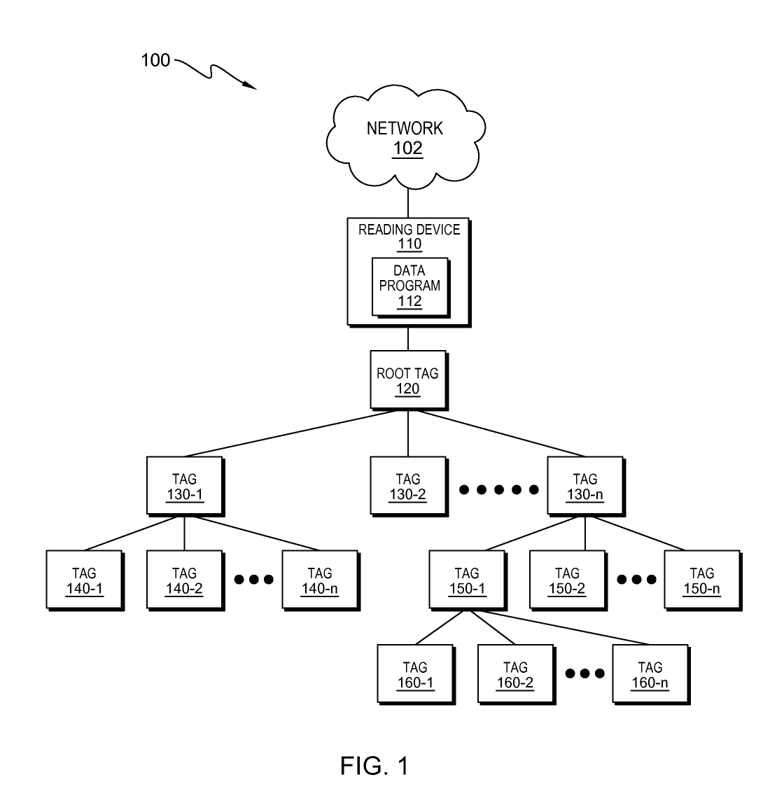

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the systems and environments in which different embodiments can be implemented. Many modifications to the depicted embodiment can be made by those skilled in the art without departing from the scope of the invention as recited by the claims.

An embodiment of data processing environment 100 includes reading device 110 connected to network 102, root tag 120, and any number of tags (e.g. tag 130-1, 130-2, 130-n). Network 102 can be, for example, a local area network (LAN), a telecommunications network, a wide area network (WAN) such as the Internet, or any combination of the three, and include wired, wireless, or fiber optic connections. In general, network 102 can be any combination of connections and protocols that will support communications between reading device 110 and any other computer connected to network 102, in accordance with embodiments of the present invention.

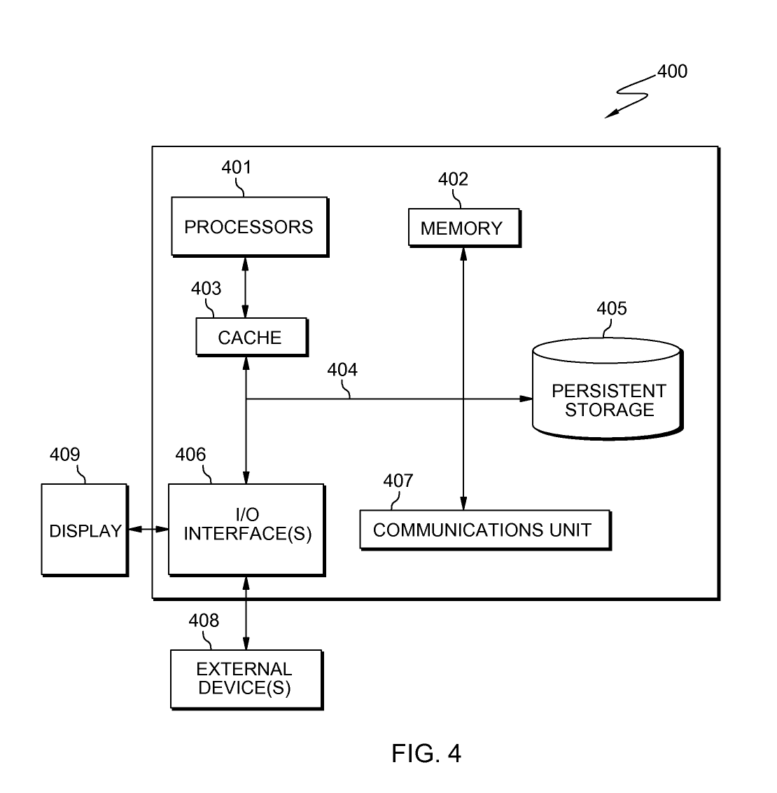

In example embodiments, reading device 110 can be a laptop, tablet, or netbook personal computer (PC), a desktop computer, a personal digital assistant (PDA), a smart phone, or any programmable electronic device capable of communicating with any computing device within data processing environment 100. In certain embodiments, reading device 110 collectively represents a computer system utilizing clustered computers and components (e.g., database server computers, application server computers, etc.) that act as a single pool of seamless resources when accessed by elements of data processing environment 100, such as in a cloud computing environment. In general, reading device 110 is representative of any electronic device or combination of electronic devices capable of executing computer readable program instructions. Reading device 110 can include components as depicted and described in further detail with respect to FIG. 4, in accordance with embodiments of the present invention.

In an embodiment, reading device 110 may provide power to root tag 120 or any other tags found in data processing environment 100 via the wired connection between reading device 110 and any number of tags. In an embodiment, reading device connects to root tag 120. In an alternative embodiment, reading device 110 connects to any tag found in data processing environment 100. Upon reading device 110 connecting to the root tag 120, or any other tag, the data found in the tags is transmitted to root tag 120 and then transmitted to reading device 110. In an alternative embodiment, if the tags are powered without the use of reading device 110, the information may already be transmitted to root tag 120 and the information is transmitted from reading device 110 from root tag 120. Reading device 110 only needs to be connected to root tag 120 for a short period of time to receive the information from the tags and reading device 110 can be disconnected from root tag 120. In an alternative embodiment, reading device 110 can be connected to root tag 120 for extended periods of time or permanently. In yet another embodiment, reading device 110 can transmit data to an RFID (Radio-Frequency Identification) reader. For example, reading device 110 may be permanently connected to root tag 120 and reading device 110 may transmit data that is received from root tag to an active or passive RFID reader. In yet another embodiment, reading device 110 is equipped with an interface to an external system, via network 102, allowing reading device 110 to forward tag inventory data to that system.

Reading device 110 includes data program 112. Data program 112 is a program, application, or subprogram of a larger program that may read, analyze, display and/or transmit data found in any number of tags in data processing environment 100. Data program 112 connects to any number of tags found in data processing environment 100 via reading device 110 and data program 112 receives the data found on the any number of tags. Data program 112 analyzes the received data and determines the hierarchical structure of the any number of tags found in the data processing environment 100. Data program 112 displays the analyzed data on reading device 110 for a user to view. Additionally, data program 112 can transfer the received data to any other device connected to network 102. In an alternative embodiment, data program 112 can transfer the received data to any other device that reading device 110 connects to.

A user interface (not shown) is a program that provides an interface between a user and data program 112. A user interface refers to the information (such as graphic, text, and sound) a program presents to a user and the control sequences the user employs to control the program. There are many types of user interfaces. In one embodiment, the user interface can be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computer, GUIs were introduced in reaction to the perceived steep learning curve of command-line interfaces, which required commands to be typed on the keyboard. The actions in GUIs are often performed through direct manipulation of the graphics elements.

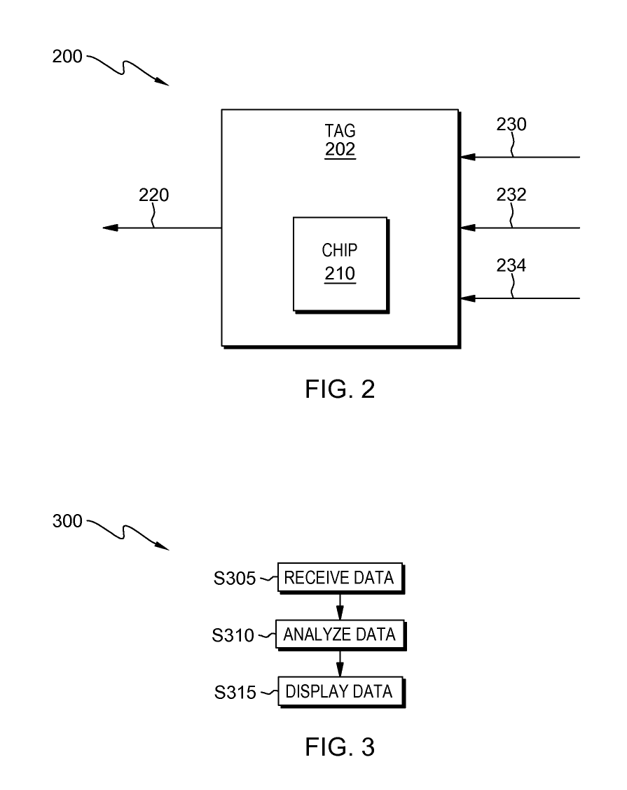

In an embodiment, data processing environment 100 includes any number of tags. The tags will be discussed in depth in reference to FIG. 2. In an embodiment, data processing environment 100 includes root tag 120. Root tag 120 is the only tag that connects directly to reading device 110 for access by data program 112. Information from all the other tags in data processing environment 100 will be transmitted through root tag 120. Root tag 120 is substantially similar to all other tags found in data processing environment.

In an embodiment, root tag 120 is connected hierarchy or organized arrangement of tags. FIG. 1 includes an example setup of tags and tags can be organized in any manner suitable for the hierarchy's required needs. As shown in FIG. 1, route tag (i.e. the downstream tag) is connected to tag 130-1, tag 130-2, and tag 130-n (i.e. the upstream tags). Tag 130-n indicates any number of tags n (i.e., 100, 1000, 10000, etc.). Tag 130-1 (i.e. the downstream tag) is connected to tag 140-1, tag 140-2, and tag 140-n (i.e. the upstream tags). Tag 140-n indicates any number of tags (i.e., 100, 1000, 10000, etc.). Tag 130-n (i.e. the downstream tag) is connected to tag 150-1, tag 150-2, and tag 150-n (i.e the upstream tags). Tag 150-n indicates any number of tags n (i.e., 100, 1000, 10000, etc.). Tag 150-2 (i.e. the downstream tag) is connected to tag 160-1, tag 160-2 and tag 160-n (i.e., the upstream tags). Tag 160-n indicates any number of tags n (i.e., 100, 1000, 10000, etc.). As discussed previously, data processing environment 100 can consist of any number of tags and FIG. 1 is an example setup of tags. In an embodiment, each tag is connected to a downstream tag (i.e. a tag that is next in line towards the root tag 120) and may be connected to any number, including none, of downstream tags (i.e. a tag that is next in line away from the root tag 120). In an alternative embodiment, a first tag may be connected to second tag that has the same downstream tag as the first tag. For example. Tag 150-2 could be directly connected to tag 130-n, tag 150-1, tag 160-1, 160-2, and 160-n.

In an embodiment, each tag may be connected to an item. The item may be, for example, a vehicle, a piece of equipment, a shipping container, etc. In an alternative embodiment, each does not have to be connected directly to the item. In an embodiment, each tag has information regarding the item that the tag is associated with.

In an embodiment, all tags, including root tag 120, are connected via a physical wire able to conduct electricity. In addition, reading device 110 and root tag 120 are connected via a physical wire able to transmit data using low voltage electric transmissions. For example, the physical wires transmit data using low voltage electrical transmissions similar to Universal Serial Bus cables or devices, as known in the art. The physical wire connecting tags is able to conduct electricity from reading device 110 to any number of tags in data processing environment 100 so as to power the any number of tags. In an embodiment, the physical wire is one-directional (i.e., information flows from the upstream tag to the downstream tag) allowing data to transfer from the upstream tag to the downstream tag. In an alternative embodiment, the physical wire is bi-directional (i.e., formation flows from the upstream tag to the downstream tag and vice versa) and therefore the reading device 110 can be connected to any tag in data processing environment 100 so as to collect data from any tags that are connected to the tag connected to the reading device 110.

FIG. 2 is a functional block diagram illustrating a tag, generally designated 200, in accordance with one embodiment of the present invention. FIG. 2 provides only an illustration of one implementation and does not imply any limitations with regard to the systems and environments in which different embodiments can be implemented. Many modifications to the depicted embodiment can be made by those skilled in the art without departing from the scope of the invention as recited by the claims.

An embodiment of data processing environment 100 includes tag 202. Tag 202 includes chip 210 along with downstream connection 220 and upstream connection 230, upstream connection 232 and upstream connection 234. In an embodiment, chip 210 may be a microchip or any other electronic circuitry capable of storing and transmitting the digital identification data and any other data of tag 202. Additionally, chip 210 may be a microchip or any other electronic circuitry capable of transmitting data of other tags received by tag 202 via an upstream connection and transmitted to the downstream connection 220. In an embodiment, tag 202 receives power for chip 210 from the downstream connection 220 via reading device 110. In an alternative embodiment, tag 202 has its own power source (not shown) to provide power for chip 210. The power source could come in the form of a battery, direct connection to a power source via another connection (not shown), or any other form of power source. Tags powered with their own power source have the capability to store data from other tags in data processing environment 100. For example, when a reading device 110 is not connected to root tag 120, tag 202 may still log and retain information about any and all tags found in data processing environment, including information about tags being connected and disconnected from data processing environment, and this information can be transmitted to reading device 110 at a later time. Additionally, tag 202 can transmit data to other tags, including root tag 120, or reading device at intervals which are a programmable feature of tag 202. Alternatively, applying power to tag 202 at prescribed intervals may be a mechanism to control transfer of data at regular intervals between a tag 202.

In an embodiment, tag 202 also includes an enclosure to house chip 210 along with any of the connections (e.g., upstream and downstream). The enclosure can be plastic, metal, wood, or any other material. In an embodiment, the enclosure surrounds chip 210. In an alternative embodiment, chip 210 may slide, clip, etc., into the enclosure but chip 210 may not be completely covered. The enclosure includes connections for the wires of downstream connection 220, upstream connection 230, upstream connection 232, and upstream connection 234. In an embodiment, there is a single upstream connection and one or more downstream connections. In an alternative embodiment, there are one or more upstream connections and one or more downstream connections. The connections allow the wiring to connect to chip 210 so as to allow tag 202 to communicate with at least one other tag.

In an embodiment, tag 202 may include an attached or integrated sensor (not shown). Possible sensors include, but are not limited to: temperature, humidity, motion detection, and tamper detection sensors. In an embodiment, tag 202 may provide power to these sensors and data taken from the sensors is stored on tag 202. In an alternative embodiment, the sensors can receive power externally and data take from the sensors can be stored on the sensors directly until reading device 110 is connected to root tag 120 at which time, reading device 110 receives the stored data from the sensors. In an embodiment, reading device 110, upon connecting to root tag 120, may write information in tag 202 or may activate, deactivate, or configure the sensors if the wires are bi-directional, as discussed previously. Additionally, reading device 110, upon connecting to root tag 120, may erase tag storage data to free up data space.

In an embodiment, tag 202 is a repository for information. At the most basic level, tag 202 stores data and then transmits the data along with a unique address (i.e., identifier) for tag 202. In an alternative embodiment, tag 202 is used to capture upstream tag information and then relay all of the information to downstream tags. Tag 202 storage can be used to store a multitude of data. For example, tag 202 can store data related to dates, temperature, humidity, motion, tampering, network identification, etc., from attached sensors, discussed previously.

In an embodiment, data is passed from tag to tag via the wires, discussed previously, then to root tag 120 and eventually to reading device 110. The data is passed in a data “packet” format that communicates the hierarchical relationship of attached tags. In other words, each tag collects the data sent by the upstream connection (i.e. tags), collates the upstream data into a new data packet that also includes the tags own data, and then forwards this new data packet to its downstream (i.e., tags, reading device) connection. In an alternative embodiment, the data may be transmitted by each tag in an existing data format, for example, UPC (Universal Product Code), EPC Gen2 (EPCglobal UHF Class 1 Generation 2), etc., allowing for integration with other types of automated identification systems and existing inventory reporting software. In an alternative embodiment, data could include programmable data including, but not limited to, expiration dates, inspection dates, the data an item was placed into inventory, the last date an item was inventoried, and shipping information. In yet another alternative embodiment, the reporting of hierarchical data could be option allowing for quicker response time when the reading device 110 needs a list of the tags in data processing environment 100 but not necessarily their relationships to each other.

FIG. 3 is a flowchart of workflow 300 depicting operational steps for data processing in a wired environment, in accordance with an embodiment of the present invention. In one embodiment, the steps of the workflow are performed by data program 112. Alternatively, steps of the workflow can be performed by any other program while working with data program 112. In an embodiment, data program 112 can invoke workflow 300 upon reading device 110 connecting to root tag 120. In an alternative embodiment, data program 112 can invoke any step of workflow 300 upon a request from a user via the user interface of reading device 110 or upon a request from a user via any other device connected network 102.

Data program 112 receives data (step S305). In an embodiment, reading device 110 is connected to root tag 120. In an alternative embodiment, reading device 110 is connected to any other tag in data processing environment 100. Data program 112, upon reading device 110 connecting, receives the data from root tag 120. As discussed previously, in an embodiment, reading device 110 is powered and provides power to root tag 120 and then to the other tags found in data processing environment 100. In an embodiment, upon the tags receiving power, any data stored in the tags is transmitted to downstream tags until the data is eventually received by data program 112 upon reading device 110 connecting to root tag 120. In an alternative embodiment, the tags may be individually powered, as discussed previously, and all data may already be transmitted downstream to root tag 120 and the data is received by data program 112 from root tag 120 upon reading device 110 connecting to root tag 120.

Data program 112 analyzes data (step S310). In an embodiment, the received data is analyzed by data program 112. For example, data program 112 may analyze the data to determine the hierarchy or relationship of the tags that the data came from. In another example, data program may extract data related to additional sensors. In an alternative embodiment, upon analyzing the received data, data program 112 may transmit, via reading device 110, to the tags in data processing environment 100, to delete or remove the data currently found in the tags.

Data program 112 displays data (step S315). In an embodiment, data program 112 may display the analyzed data (step S310) on the user interface, discussed previously, of reading device 110. For example, data program 112 may display the hierarchical structure of the tags found in data processing environment 100 for viewing by a user. In another example, data program 112 may display the data from the additional sensors found in data processing environment 100 for viewing by a user. In an alternative embodiment, data program 112 may transmit, via reading device 110, the data to another device (not shown) and another program, for analysis and display by the other program by the other device. In yet another embodiment, data program 112 and reading device 110 may work in conjunction with another device (not shown) and another program (not shown), to analyze and display the data.

FIG. 4 depicts computer 400 that is an example of reading device 110 that includes data program 112. Computer 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system for inventory management, the system comprising:
a plurality of tags, wherein each tag of the plurality of tags corresponds to an item and wherein each tag of the plurality of tags is connected via a wire to at least one other tag of the plurality of tags;
a root tag connected via a wire to at least one tag of the plurality of tags; and
a reading device, wherein the reading device is connected to the root tag to receive data found on the plurality of tags and wherein the data is transferred to the reading device through one or more wires connected to the root tag.

2. The system of claim 1, wherein the reading device provides power to the root tag and one or more tags of the plurality of tags.

3. The system of claim 1, wherein the wire is one of the following: one-directional; and bi-directional.

4. The system of claim 1, wherein the data transferred to the reading device is stored in a hierarchical structure.

5. The system of claim 1, wherein at least one of the tags of the plurality of tags includes a power source.

6. The system of claim 1, wherein at least one of the tags of the plurality of tags includes a downstream connection.

7. The system of claim 1, further comprising:
one or more sensors connected to at least one tag of the plurality of tags, wherein the sensor of the one or more sensors transmits data to the tag the sensor is connected to.

8. The system of claim 1, wherein each tag of the plurality of tags are configured to erase the data upon transferring the data.

9. The system of claim 1, wherein each tag of the plurality of tags has a chip that transfers the data between each tag of the plurality of tags and the root tag.

10. A method for inventory management, the method comprising the steps of:
receiving data through a root tag that is connected via a wire to at least one tag of a plurality of tags, wherein the data is received by a reading device connected to the root tag and wherein each tag of the plurality of tags corresponds to an item and wherein each tag of the plurality of tags is connected via a wire to at least one other tag of the plurality of tags.

11. The method of claim 10, wherein the reading device provides power to the root tag and one or more tags of the plurality of tags.

12. The method of claim 10, wherein the wire is one of the following: one-directional; and bi-directional.

13. The method of claim 10, wherein the data transferred to the reading device is stored in a hierarchical structure.

14. The method of claim 10, wherein at least one of the tags of the plurality of tags includes a power source.

15. The method of claim 10, wherein at least one of the tags of the plurality of tags includes a downstream connection.

16. The method of claim 10, wherein one or more sensors are connected to at least a tag of the plurality of tags and wherein each sensor of the one or more sensors transmits data to the tag the sensor is connected to.

17. The method of claim 10, wherein each tag of the plurality of tags erase the data upon transferring the data.

18. The method of claim 10, wherein each tag of the plurality of tags has a chip that transfers the data between each tag of the plurality of tags and the root tag.

19. A computer program product for inventory management, the computer program product comprising:
one or more computer readable storage media; and
program instructions stored on the one or more computer readable storage media, the program instructions comprising:
program instructions to receive data through a root tag that is connected via a wire to at least one tag of a plurality of tags, wherein the data is received by a reading device when the reading device is connected to the root tag and wherein each tag of the plurality of tags corresponds to an item and wherein each tag of the plurality of tags is connected via a wire to at least one other tag of the plurality of tags.

20. The computer program product of claim 19, wherein one or more sensors are connected to at least a tag of the plurality of tags and wherein each sensor of the one or more sensors transmits data to the tag the sensor is connected to.
